(19) United States
(12) Patent Application Publication
(10) Pub. No.: US 2022/0403691 A1
(43) Pub. Date: Dec. 22, 2022

(54) DOOR DRIVE WITH A MOTOR UNIT, HAVING AN ADVANTAGEOUS BASIC SHAPE

(71) Applicant: dormakaba Deutschland GmbH, Ennepetal (DE)

(72) Inventors: Andreas FINKE, Ennepetal (DE); Dietmar FINIS, Ennepetal (DE); Martin WAGNER, Ennepetal (DE); Sven BUSCH, Ennepetal (DE)

(21) Appl. No.: 17/782,861

(22) PCT Filed: Nov. 25, 2020
(86) PCT No.: PCT/EP2020/083346

§ 371 Date: Jun. 6, 2022

(30) Foreign Application Priority Data
Dec. 9, 2019 (EP) 19214422.8

(51) Int. Cl. E05F 15/643

(52) U.S. Cl. CPC E05F 15/643; E05Y 2201/10; E05Y 2201/442; E05Y 2800/205; E05Y 2900/132; E05Y 2600/626; E05Y 2600/632

(57) ABSTRACT

A door drive for arrangement on or in connection with a door system, wherein at least one leaf element of the door system is movable, including a motor unit with a housing, in which a stator is stationarily received, and wherein a rotor is arranged so as to be rotationally-movable in the housing and includes an output shaft, wherein the output shaft can be brought into operative connection in a driving manner with the leaf element. The motor unit has the basic shape of a cuboid, which is formed at least by two housing halves connected to each other.

### TECHNICAL FIELD

The disclosure relates to a door drive for arrangement on or in connection with a door system, by means of which drive at least one leaf element of the door system is movable, including a motor unit with a housing, in which a stator is stationarily received and wherein a rotor is arranged so as to be rotationally-movable in the housing and includes an output shaft, wherein the output shaft can be brought into operative connection in a driving manner with the leaf element. Furthermore, the disclosure relates to a door system with such a door drive, including at least one leaf element, with which the door drive is in operative connection in a driving manner.

### BACKGROUND

A door drive for arrangement on a door system is known from DE 10 2008 046 062 A1, and the drive serves to move leaf elements of the door system, which is formed as an automatic sliding door. For this purpose, the door drive includes a motor unit with a housing, and a gear unit, which is embodied as a worm gear and is attached to the housing of the motor unit. Thus, the motor unit is designed as a high-speed motor, and the gear unit reduces the higher rotational speed of the rotor of the motor unit to a lower rotational speed for driving a belt pulley, which is placed on an output shaft of the gear unit.

A toothed belt, which is connected to the leaf elements of the automatic sliding door, is placed over the belt pulley. Since the motor unit is designed to rotate at high speed, and the rotational speed needs to be reduced to the belt pulley, the gear unit is necessary in conjunction with the motor, whereby additional construction space is required and whereby the construction of the door drive is more complex. The spatial dimensioning of the door drive needs to be adapted to the requirements of the gear unit, and since the motor has a cylindrical basic shape, it takes up the construction space, which, in terms of the installation environment, does not allow for optimum use of the space. The same applies to a worm gear, which, in particular in conjunction with the motor, requires a lot of construction space.

DE 10 2014 115 932 A1 discloses another door drive, and the door drive includes a one-piece cuboidal body as the basic body, into which recesses are introduced for receiving a motor unit and a gear stage. In order to also receive a controller, a power unit and the like, further recesses and openings are provided in the block. Thus, the cuboidal body forms a housing as a support for the individual components of the door drive and is embodied as one piece and, in a sense, monolithically over the entire dimension of the drive.

Basically, when constructing door drives for arrangement on or for arrangement in connection with a door system, the aim is to embody the door drive as compact as possible and with small dimensions, for example by a gear unit or a gear stage already being avoided within the door drive. Usually, door drives are arranged above the linearly movable leaf elements of an automatic sliding door system and have a support profile, which forms a basic body of the door system and the door drive is mounted on the support profile in an integrated manner and likewise the leaf elements are linearly guided thereon. Generally, a toothed belt serves as the connecting means between the door drive and the leaf elements, wherein other traction means, such as chain connections and the like are also possible. The door drive with at least the motor, a power unit and a controller thereby forms a separate structural unit, which, when arranged on the support profile, is integrated into the door system.

In order to embody the support profile with a corresponding screen, a housing or other adjacent parts so as to be as small as possible, it is advantageous to also embody in particular the door drive itself as compact as possible and with small dimensions. However, since leaf elements made of glass can have large masses, the door drive must have a high power density, in order to be able to correspondingly strongly accelerate and also to decelerate such leaf elements, so that the door system, even with large leaf elements, still achieves suitable dynamics.

For a high power density and in particular a low-noise operation, motor units in conjunction with a toothed belt as direct drives are suitable, in which the belt pulley is directly installed on the output shaft of the motor unit, over which belt pulley the toothed belt is placed, which in turn is directly connected to the leaf elements. As a result, the door drive can be operated with minimum noise, because high rotational motor speeds are not reached, and with a corresponding design of the motor unit, power densities can be provided, which are sufficient to sufficiently strongly accelerate and also to decelerate leaf elements of for example 200 kg to 250 kg for operating an automatic sliding door.

Motor gear units with a cylindrical outer motor shape and a worm gear arranged transversely thereto do not allow for a particularly high integration density, in particular with regard to the output power that can be provided at the output shaft. Furthermore, the further compact arrangement of a power unit, a controller and for example an operating part proves to be difficult while maintaining a high integration density.

### SUMMARY

The disclosure provides a door drive with a motor unit, which has a high integration density and a high power density, and wherein the motor in conjunction with the at least one leaf element is to be embodied in particular as a direct drive. Moreover, the high integration density of the door drive is to be achieved by the arrangement of motor unit in connection with a power unit and a controller, as well as with further components, for example an operating part. Furthermore, in this case, it should be considered that the door drive can be integrated into a support profile of a door system without requiring larger space, in particular in order to embody the support profile with smaller dimensions.

This is achieved by providing a door drive according to claim 1 and based on a door system according to claim 15 with the respectively characterizing features. Advantageous further developments of the disclosure are indicated in the dependent claims and in the description.

The disclosure includes the technical teaching that the motor unit has the basic shape of a cuboid, which is formed at least by two housing halves connected to each other.

In the context of the disclosure, a cuboid is a body, which is delimited by six rectangular surfaces, wherein the rectangular surfaces should be substantially, but not completely, flat, i.e. they can certainly have moldings, curvatures, inclinations, ribs and the like. In this respect, in the context of the disclosure, the cuboidal shape of the motor unit is to be understood almost in mathematical terms; a rectangular body with slight angular deviations and shape deviations is thus also covered by the term cuboid, without sticking to the mathematical term of a cuboid. Since, according to the disclosure, only the basic shape of the motor unit is to form a cuboid, the basic shape can also be understood as an envelope shape, without the housing of the motor unit exactly forming a cuboidal envelope shape.

The motor unit embodied according to the disclosure can, with the cuboidal shape, be advantageously incorporated into a door drive, and the formed lateral surfaces, the end surface as well as the flat rear side allow for a simple design of the door drive with directly adjoining further components, in particular components, such as the power unit, the controller and the like. In particular, a cuboidal body can be particularly advantageously arranged in or on a support profile such that the door drive can have smaller dimensions in its entirety.

The housing halves can be embodied in a half-shell shape, and if the housing halves are connected to each other, the thus formed housing body is completed and forms a cuboid. In this case, the housing halves do not necessarily have to form an exact half of the housing, and the separating plane between the housing halves does not have to be located at half the height of a vertical edge of the cuboid. In this respect, housing halves can also be provided, which can have different measurements, forms and dimensions, however, they can be placed on top of each other and connected in a way to create the cuboid for forming the housing, and to thus form the basic shape of the motor unit.

Advantageously, the housing halves are configured such that at least the stator and the rotor are received on the inside between the housing halves. In particular, the housing halves can be embodied like shells and are indirectly or directly connected to each other. If the housing halves are directly connected to each other, a circumferential, almost rectangular, border of the respective housing half is joined one on top of the other, wherein if the housing halves are indirectly connected to each other, an intermediate element can also be arranged between the housing halves, for example a sealing element or the like.

The cuboid particularly advantageously has a longitudinal edge, a width edge and a vertical edge, wherein the longitudinal edge is greater than the width edge and/or wherein the width edge is greater than the vertical edge. For example, the width edge has a length of 70% to 98%, in particular of 85% to 95%, of the length of the longitudinal edge. The vertical edge has a length of 30% to 60%, in particular of 40% to 50%, of the length of the longitudinal edge. If the length of the longitudinal edge is 100 mm, for example, then the width edge has a length of 90 mm, for example and the vertical edge has a length of 40 mm to 50 mm, for example.

In particular when the width edge has a smaller measurement than the longitudinal edge, the motor unit can be integrated in the door drive such that the width edge extends vertically such that, in particular in arrangement above the leaf elements, the door drive can be designed with a low construction height, which is determined by the construction height of the door drive, and the construction height of the door drive is in turn determined by the width of the motor unit, namely by the length of the width edge.

Further advantageously, an end surface spans the longitudinal edge and the width edge, wherein the output shaft protrudes perpendicularly on the end surface. A belt pulley is attached on the protruding section of the output shaft, and the end surface can be embodied free from fastening means such that the belt can be guided as close as possible above the end surface, when the belt pulley is guided up to in front of the end surface.

Further advantageously, the door drive includes at least one power unit and at least one controller, wherein the power unit and the controller are at least indirectly arranged on the opposite lateral surfaces of the cuboid, wherein the opposite lateral surfaces span the width edge and the vertical edge of the cuboid. In this respect, the power unit and the controller are arranged in the extension of the extension direction of the longitudinal edge of the cuboid of the motor unit, which is advantageous, when the longitudinal edge of the motor unit extends parallel to the longitudinal direction of a support profile of the door drive. The integration of the door drive is not as critical for the construction space in this direction as in a transverse direction thereto such that the longitudinal edge has the largest dimension of the cuboid of the motor unit. The indirect arrangement of the power unit and/or of the controller on the motor unit relates to an arrangement, in which at least one further component is present between the power unit and/or the controller and the motor unit, for example a mount or a flange.

It is also advantageous to electrically insulate the motor unit together with the power unit and/or the controller such that an insulating element can also adjoin the lateral surfaces of the motor unit.

Further advantageously, a first flange element is provided, which is arranged on the first lateral surface and receives the power unit and/or a second flange element is provided, which is arranged on the second lateral surface and receives the controller. Thus, in particular, the motor unit is received so as to be retained in the door drive via the two flange elements. By arranging the flange elements on the lateral surfaces, the end surface can be embodied free from fastening means and in particular free from flange elements such that the toothed belt, which is placed over the belt pulley, can run freely and as close as possible over the end surface.

Particularly advantageously, the basic body of the door drive is formed with the support profile, which for example forms an L-shaped aluminium profile, and, with regard to a subsequent installed position, the motor unit can be aligned to and arranged on the support profile such that the output shaft has a horizontal extension. This results in a course of the belt with belt strands vertically arranged one above the other. This embodiment is advantageous with regard to the required movement of the leaf elements and advantageous with regard to an integration of a blocking device for the leaf elements, which are brought into connection with the belt.

The flange elements are embodied such that they are fastened to the support profile such that the motor unit is arranged on the support profile by means of the flange elements. The flange elements form sheet metal parts manufactured in a punch and bend process, which are formed such that the motor can be attached via its lateral surfaces with the flange elements in the support profile and the sheet metal elements also receive the power unit on the one side of the motor unit and the controller on an opposite side of the motor. Furthermore, an operating and display part and further components for operating the door drive can likewise be received by means of the flange elements.

The stator of the motor unit has a substantially round basic shape such that corner areas are formed in the body of the cuboid, in which are arranged screw bores for arranging the flange elements and/or a screw arrangement for screwing the housing halves one on top of the other and/or a screw arrangement for screwing the stator to one of the housing halves. Thus advantageously, the configuration of the motor unit with a substantially ring-shaped stator and a cuboidal housing results in the possibility of integrating the fastening means in the corner areas such that the motor unit itself likewise has a high spatial integration density and the rest of the structural areas do not remain unused in terms of space. For further improved cooling, the lateral surfaces can have a fin structure, which does not hinder the mounting of the flange elements.

Despite smaller deviations, such as screw receiving portions and the like, the stator has a substantially ring-shaped basic structure and the stator is received in at least one of the housing halves such that an at least partially circumferential heat transition gap is formed between the radial outer side of the stator and the inner side receiving area of the housing half. In order to serve for transferring heat from the stator into the at least one or into both housing halves, said heat transition gap is designed with values of for example between 0.05 mm to 0.1 mm such that a transition fit results between the stator and the receiving area of the stator in the housing half or in both housing halves. Heat developing in the stator due to the operation of the motor unit can advantageously transfer to the housing halves and the same can dissipate it to the environment.

Further advantageously, the stator includes surface sections on two opposite outer sides of the cuboid, wherein the surface sections correspond to window-like recesses in the opposite outer sides of the cuboid. In this case, at least one of the surface sections of the stator is brought into heat-transferring contact with the support profile through the window-like recess. Alternatively or additionally, at least one of the surface sections of the stator can be brought into heat-transferring contact with a separate cooling body through the window-like recess.

Furthermore, the disclosure relates to a door system with a door drive having the above-described features. The door system can include a connecting element to connect to a leaf element. Additionally or alternatively, the door system can include at least one leaf element, with which the door drive is operatively connected in a driving manner.

For example, the door system can be formed as a sliding door system. The sliding door system can comprise a belt, in particular a toothed belt. The connecting element can be at least indirectly connected to the belt. The connecting element can be formed as a slider, in particular as a roller carriage. The connecting element can run in a rail, in particular in a rail of the support profile. The belt can be tensioned between belt pulleys of the door system. One of the belt pulleys can be formed as the belt pulley of the door drive according to the disclosure.

### BRIEF DESCRIPTION OF THE DRAWINGS

Further measures improving the disclosure are represented below in detail together with the description of one preferred exemplary embodiment of the disclosure based on the figures, in which is shown:

FIG. 1 an overall view of the door drive with a motor unit, which has the structural shape according to the disclosure,

FIG. 2 a perspective view of the motor unit according to the disclosure,

FIG. 3 a perspective view of the motor unit according to FIG. 2, wherein one housing half is removed from the view, and

FIG. 4 a view of a further housing half of the motor unit with a stator and an output shaft.

### DETAILED DESCRIPTION OF THE DRAWINGS

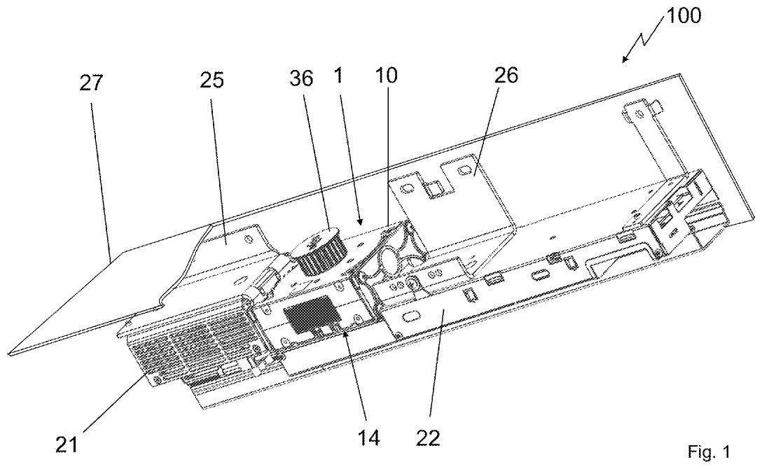

FIG. 1 shows an overall view of the door drive 100, as the same can be installed in a building, with the installation on ships and in airplanes also being included, and a door drive 100 of this type serves for example as a drive for an automatic sliding door system. The basic structure of the door drive 100 forms a support profile 27, which, for a simpler view, is illustrated shortened, moreover the essential upper part of the L-shaped support profile 26 is shown sectioned in order to further reveal the further essential components of the door drive 100 in this case.

As a central component, the door drive 100 includes a motor unit 1, and the motor unit 1 has the basic shape of a cuboid 14, which forms the housing 10 of the motor unit 1. In order to enable an output and therefore a connection to a leaf element, not represented in more detail, of a door system, a belt pulley 36 is arranged on the motor unit 1, over which a toothed belt can be placed, which ultimately establishes the connection to the leaf element/s, for example the glass sliding elements.

Adjacent to the motor unit 1, the door drive 100 includes a power unit 21 and a controller 22, and the power unit 21 and the controller 22 are arranged at opposite sides of the motor unit 1. The motor unit 1 is fastened to the support profile 27 with a first flange element 25, wherein the first flange element 25 simultaneously receives the power unit 21. Furthermore, the motor unit 1 is connected to the support profile 27 with a second flange element 26, wherein the second flange element 26 simultaneously receives the controller 22. Alternatively, the embodiment of a single flange is also possible in order to receive at least the motor unit 1, the power unit 21 and the controller 22. Furthermore, there is the possibility for the motor unit, the power unit 21 and/or the controller 22 to include respectively assigned separate flange elements for arrangement in or on the support profile 27.

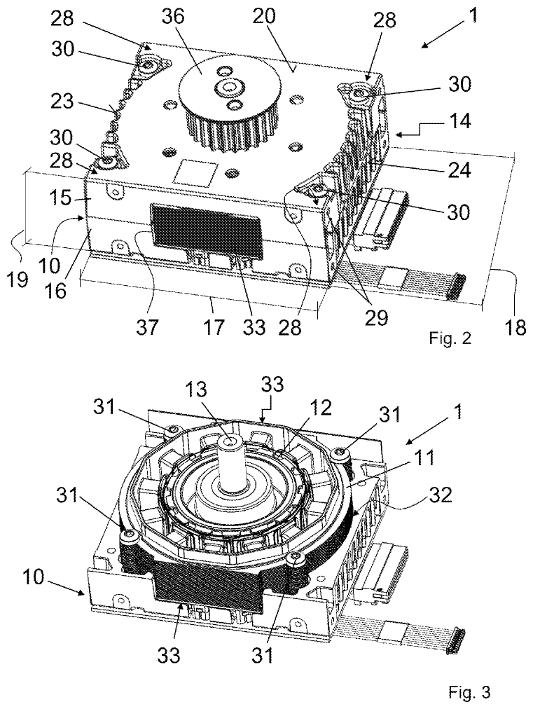

FIG. 2 shows a perspective view of the isolated motor unit 1 with the housing 10, and in the representation at the top side, the belt pulley 36 for coupling a toothed belt above the end surface 20 of the housing 10 is located outside the housing 10. The housing 10 of the motor unit 1 includes a first upper housing half 15, and a second lower housing half 16, which by way of example are embodied in the same way, however, within the scope of the disclosure, they do not have to be embodied in the same way. The housing 10 is laterally delimited by a first lateral surface 23 and an opposite second lateral surface 24, and the flange elements 25 and 26, shown in FIG. 1, can be arranged on the lateral surfaces 23 and 24.

The cuboid 14 formed with the housing 10 has corner area 28, and screw bores 29 for fastening the flange elements 25, 26 are introduced into the respective corner areas 28 by means of screw elements, of which two screw bores 29 are numbered by way of example. Furthermore, screw arrangements 30 for screwing the housing halves 15 and 16 to each other are located in the corner areas.

The cuboid 14 is determined by the longitudinal edge 17, the width edge 18 and the vertical edge 19, wherein the lateral surfaces 23, 24 are spanned by the width edge 18 and the vertical edge 19.

The front-side surface, which is spanned by the longitudinal edge 17 and the vertical edge 19, has a window-shaped recess 37, from which protrudes a surface section 33 of the stator, which is not represented in this view, wherein reference is made to FIG. 3 in relation to the stator 11. The surface section 33 of the stator 11 pointing outwards serves for heat-transferring contact with a further body, for example with the support profile 27 or with another separate cooling body. As a result, despite the housing 10 with the upper and lower housing half 15, 16 being embodied substantially closed, the stator 11 can be brought into direct heat-transferring contact with a component adjacent to the motor.

The stator 11 according to the representation of FIG. 3, is screwed to the lower housing half 16 with the screw arrangement 31, and on the front side as well as on the rear side of the stator 11, there are respective surface sections 33 in opposite arrangement, which, as described above, form one surface section of the outer skin of the motor unit 1.

With the first housing half 15 removed, the stator 11 is shown with the rotor 12 arranged within the stator 11, wherein the rotor 12 is formed uniformly with the output shaft 13, which is guided out of the upper housing half 15, and the part of the output shaft 13 extending from the end surface 20 of the housing 10 receives the belt pulley 36.

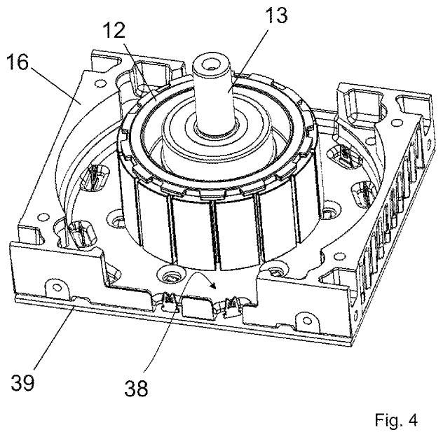

In an overview with FIG. 3, FIG. 4 shows, in a further representation, the lower housing half 16, wherein the rotor 12 is also shown with the output shaft 13. Within the housing half 16, but also not shown in more detail in the housing half 15, is located a substantially ring-shaped receiving area 38, in which the stator 11 is received. FIG. 3 shows a heat transition gap 32, which results as an at least partially circumferential annular gap between the outer side of the stator 11 and the inner shell surface of the receiving area 38.

If the motor unit 1 is operating, the stator 11 is heated by energizing the winding on the stator 11, not shown in detail, and the heat from the stator 11 can transfer into the housing halves 15, 16 with the very small dimensioned heat transition gap 32. The heat transition gap 32 is thereby advantageously embodied as a transition fit. On the rear side of the cuboid 14 opposite the end face 20 is located a printed circuit board 39, on which conductor paths are arranged, which in particular serve for the contacting and wiring of the winding of the stator 11. In this case, the printed circuit board 39 is fastened with retaining elements on the housing 10 of the motor unit 1.

The design of disclosure is not limited to the above indicated preferred exemplary embodiment. In fact, a number of variants is conceivable, which make use of the represented solution, even with essentially different types of designs. All features and/or advantages including the constructive details or spatial arrangements, emerging from the claims, the description and the drawings, may be essential to the disclosure, both by themselves and in the most varied combinations.

1. A door drive for arrangement on or in connection with a door system, wherein at least one leaf element of the door system is movable, including a motor unit with a housing, in which a stator is stationarily received, and wherein a rotor is arranged so as to be rotationally-movable in the housing and includes an output shaft, wherein the output shaft is configured to be brought into operative connection in a driving manner with the leaf element,
wherein the motor unit has the basic shape of a cuboid, which is formed at least by two housing halves connected to each other.

2. The door drive according to claim 1, wherein the stator and the rotor are received on the inside between the housing halves and/or wherein the housing halves are formed to rest indirectly or directly on each other.

3. The door drive according to claim 1, wherein the cuboid has a longitudinal edge, a width edge and a vertical edge, wherein the longitudinal edge is greater than the width edge and/or wherein the width edge is greater than the vertical edge.

4. The door drive according to claim 3, wherein the width edge has a length of 70% to 98% and/or of 85% to 95%, of the length of the longitudinal edge and/or in that the vertical edge has a length of 30% to 60% and/or of 40% to 50% of the length of the longitudinal edge.

5. The door drive according to claim 3, wherein the longitudinal edge and the width edge span an end surface, wherein the output shaft protrudes perpendicularly from the end surface.

6. The door drive according to claim 1, wherein at least one power unit and one controller are present, wherein the power unit and the controller are arranged at least indirectly on opposite lateral surfaces of the cuboid (14), wherein the opposite lateral surfaces span the width edge and the vertical edge of the cuboid.

7. The door drive according to claim 1, wherein a first flange element is provided, which is arranged on a first lateral surface and receives the power unit, and/or in that a second flange element is provided, which is arranged on a second lateral surface and receives the controller, wherein the motor unit is received so as to be retained in the door drive via the two flange elements.

8. The door drive according to claim 1, wherein a basic body of the door drive is formed by a support profile, wherein the motor unit, with regard to a subsequent installed position, is aligned to the support profile such that the output shaft has a horizontal extension.

9. The door drive according to claim 8, wherein the flange elements are fastened to the support profile such that the motor unit is arranged on the support profile by the flange elements.

10. The door drive according to claim 1, wherein the stator has a substantially round basic shape such that corner areas are formed in the cuboid, in which are arranged screw bores for arranging the flange elements and/or a screw arrangement for screwing the housing halves one on top of the other and/or a screw arrangement for screwing the stator to one of the housing halves.

11. The door drive according to one of the preceding claim 1, wherein the stator has a ring-shaped basic structure and is received in at least one of the housing halves, wherein an at least partially circumferential heat transition gap is formed between the radial outer side of the stator and the inner side of the housing half.

12. The door drive according to claim 1, wherein the stator includes surface sections on opposite outer sides of the cuboid, wherein the surface sections correspond to at least one recesses in the opposite outer sides of the cuboid.

13. The door drive according to claim 12, wherein at least one of the surface sections of the stator is brought into heat-transferring contact with the support profile through the at least one recess.

14. The door drive according to claim 12, wherein at least one of the surface sections of the stator is brought into heat-transferring contact with a separate cooling body through the at least one recess.

15. A door system with a door drive according to of claim 1, including at least one connecting element for connecting to a leaf element and/or at least one leaf element, with which the door drive is operatively connected in a driving manner.
